(19) United States
(12) Patent Application Publication
(10) Pub. No.: US 2025/0127592 A1
(43) Pub. Date: Apr. 24, 2025

(54) MAGNETIC TRACTION DEVICE FOR IMPACTED TOOTH

(71) Applicant: LIANG-CHENG CHEN, Taichung City (TW)

(72) Inventor: LIANG-CHENG CHEN, Taichung City (TW)

(21) Appl. No.: 18/899,221

(22) Filed: Sep. 27, 2024

(30) Foreign Application Priority Data
Sep. 27, 2023 (TW) 112137180

(51) Int. Cl. A61C 7/00

(52) U.S. Cl. CPC A61C 7/006

(57) ABSTRACT

A magnetic traction device for impacted tooth, comprising a first magnetic component fixed to a normal tooth and a second magnetic component fixed to an impacted tooth. There is an attractive magnetic force between the first and second magnetic components, thereby pulling the impacted tooth toward the direction of the normal tooth where the first magnetic component is located.

### BACKGROUND OF INVENTION

### Field of Invention

The present invention relates to dental equipment, and more specifically to a device for pulling impacted tooth using magnetic force.

### Related Prior Art

Impacted tooth can be understood simply as a tooth that is stuck and unable to emerge. This may be due to the tooth growing in an incorrect direction, tooth whose growth positions are blocked by other tooth, tooth with abnormal shapes that prevent eruption, supernumerary teeth, or tooth covered by gums or bone, resulting in insufficient space for full eruption. For example, mandibular wisdom tooth is the most common impacted tooth. It often grows horizontally within the gums, and its roots are located close to the alveolar nerve. In the past, dental surgery has been used to directly extract an impacted tooth, a method that often causes pain and discomfort for patients. Additionally, the large bone cavities left behind after extraction can weaken the support of the adjacent teeth, making the area more prone to bacterial growth. Furthermore, the process of directly extracting an impacted tooth may damage nearby nerves due to the pulling movements involved.

### SUMMARY OF THE INVENTION

To address the aforementioned issues, the present invention provides an impacted tooth magnetic traction device, which includes:
A first magnetic component fixed to a normal tooth;
   A second magnetic component fixed to the impacted tooth, wherein an attractive magnetic force exists between the first and second magnetic components, thereby pulling the impacted tooth towards the normal tooth where the first magnetic component is located.

The first magnetic component includes a casing, a magnet or iron block housed within the casing, and a cover that seals the casing. The cover is adhered to the normal tooth.

The second magnetic component is a magnet or iron block embedded within the impacted tooth.

### BRIEF DESCRIPTION OF DRAWINGS

FIG. 1 and FIG. 2 are schematic diagrams illustrating the use state of the present invention;

FIG. 3 is a cross-sectional schematic diagram of the first magnetic component of the present invention;

FIG. 4A, FIG. 4B, and FIG. 4C are schematic diagrams illustrating the assembly of the second magnetic component with the impacted tooth in the present invention.

### DETAILED DESCRIPTION OF PREFERRED EMBODIMENT

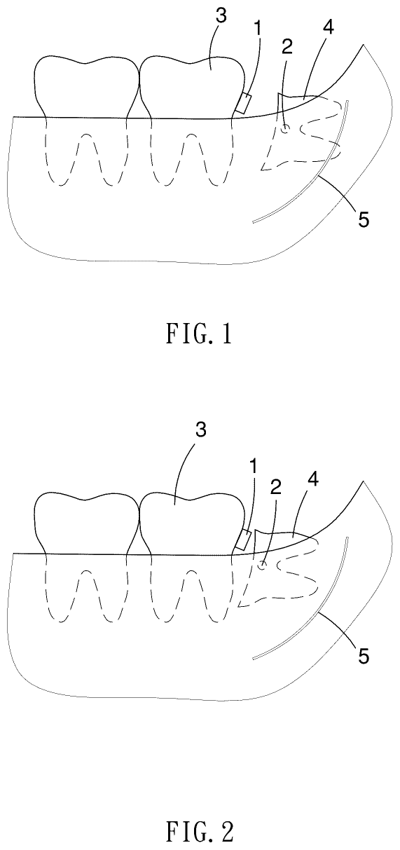

Please refer to FIG. 1, which illustrates the magnetic traction device for impacted tooth provided by the present invention, comprising a first magnetic component 1 and a second magnetic component 2. The first magnetic component 1 is fixed to a normal tooth 3, while the second magnetic component 2 is fixed to an impacted tooth 4. There is an attractive magnetic force between the first magnetic component 1 and the second magnetic component 2. In this document and the accompanying figures, the impacted tooth 4 is exemplified as a horizontally growing wisdom tooth, but the present invention is not limited to this.

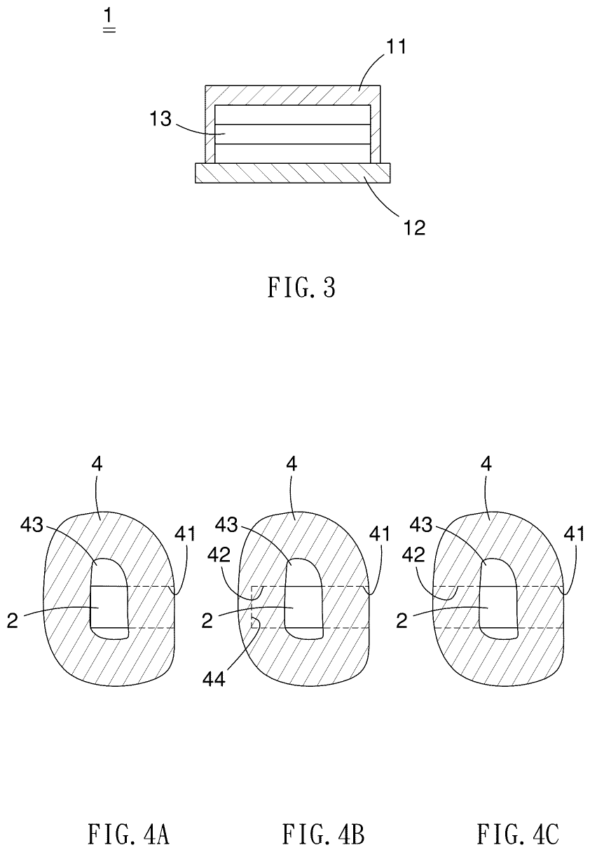

As shown in FIG. 3, the aforementioned first magnetic component 1 includes a casing 11 and a cover 12, which together form a containing space for housing at least one magnet or iron block 13. The number of magnets or iron blocks can be adjusted according to the required magnetic force. In this embodiment, the cover 12 is positioned on one side of the casing 11 and has a larger surface area than the casing 11, with the edges protruding beyond the casing 11. The cover 12 not only seals the casing 11 but also allows for adhesion to a normal tooth using adhesive, thereby securing the magnet or iron block 13 inside.

The aforementioned second magnetic component 2 is an object capable of generating magnetic force when paired with the first magnetic component 1, such as a magnetic rod or iron rod. If the first magnetic component 1 contains a magnet inside, the second magnetic component 2 can be either a magnetic rod or an iron rod; if the first magnetic component 1 contains an iron block inside, the second magnetic component 2 should be a magnetic rod. After cutting the crown of the impacted tooth 4, a hole is drilled on one side of the impacted tooth 4, creating a pathway to the pulp chamber 43. The second magnetic component 2 is then embedded into this drilled hole and secured in place. There are three possible configurations for the drilled hole:

The first configuration, as shown in FIG. 4A, involves a drilled hole with only a first side hole 41 passing through one side of the impacted tooth 4 and connecting to the pulp chamber 43. In this case, the second magnetic component 2 passes through the first side hole 41 and extends to the pulp chamber 43, resting against the opposite side wall of the impacted tooth 4 to be secured.

The second configuration, as shown in FIG. 4B, involves a drilled hole with a first side hole 41 passing through one side of the impacted tooth 4 and connecting to the pulp chamber 43, and a groove 44 located on the opposite side wall of the impacted tooth 4. In this case, the second magnetic component 2 passes through the first side hole 41, extends to the pulp chamber 43, and continues into the groove 44 to be secured.

The third configuration, as shown in FIG. 4C, involves a drilled hole with a first side hole 41 passing through one side of the impacted tooth 4 and connecting to the pulp chamber 43, and a second side hole 42 passing through the opposite side wall of the impacted tooth 4. In this case, the second magnetic component 2 passes through the first side hole 41, extends to the pulp chamber 43, and continues through the second side hole 42 to be secured.

When attempting to extract the impacted tooth 4, as shown in FIG. 1, the impacted tooth 4 may be located very close to the alveolar nerve 5. If forceps are used to grip the impacted tooth 4 and it is forcibly pulled out by shaking and tugging, there is a high risk of damaging the nerve. Additionally, the large socket left behind after extraction may not heal easily and can become a breeding ground for bacteria. However, using the structure of the present invention, the first magnetic component 1 is fixed to a normal tooth 3 as an anchor point, and the second magnetic component 2 is fixed to the impacted tooth 4. Through the attractive magnetic force between the first magnetic component 1 and the second magnetic component 2, over time, the impacted tooth 4 can gradually move in the direction of the normal tooth 3, as shown in FIG. 2, and away from the alveolar nerve 5. At this point, the impacted tooth 4 can be extracted using conventional tooth extraction methods without damaging the alveolar nerve 5, and the resulting socket will be smaller, which helps to shorten the healing period.

The above disclosure of embodiments is provided merely to illustrate the present invention and is not intended to limit the invention. Any substitution of equivalent components should fall within the scope of the present invention.

In summary, those skilled in the art will understand that the present invention can indeed achieve the aforementioned objectives and fully complies with the provisions of patent law, and thus this application is submitted in accordance with the law.

1. An impacted tooth magnetic traction device, comprising:
a first magnetic component fixed to a normal tooth;
a second magnetic component fixed to an impacted tooth without a crown, wherein there is an attractive magnetic force between the first and second magnetic components, thereby pulling the impacted tooth toward the direction of the normal tooth where the first magnetic component is fixed; wherein, the impacted tooth has two opposite side walls and a first side hole on one of the side walls, the first side hole communicates with a pulp chamber of the impacted tooth, and the second magnetic component passes through the first side hole and the pulp chamber to lean against the other side wall.

2. The impacted tooth magnetic traction device as recited in claim 1, wherein the first magnetic component comprises a casing, a magnet or iron block housed within the casing, and a cover that seals the casing, with the cover being fixedly attached to the normal tooth.

3. The impacted tooth magnetic traction device as recited in claim 2, wherein the cover is adhered to the normal tooth.

4. The impacted tooth magnetic traction device as recited in claim 1, wherein the second magnetic component is a magnet or iron block.

5. The impacted tooth magnetic traction device as recited in claim 1, wherein the impacted tooth has a groove on the other side wall, and the second magnetic component passes through the first side hole and the pulp chamber into the groove.

6. The impacted tooth magnetic traction device as recited in claim 1, wherein the impacted tooth has a second side hole on the other side wall, and the second magnetic component passes through the first side hole, the pulp chamber and the second side hole.
